(19) United States
(12) Patent Application Publication
(10) Pub. No.: US 2012/0308682 A1
(43) Pub. Date: Dec. 6, 2012

(54) RUMINANT FEED, PRODUCTS, AND METHODS COMPRISING BENEFICIAL FATTY ACIDS

(75) Inventors: Dale Elton Bauman, Ithaca, NY (US); Gary F. Hartnell, St. Peters, MO (US); Nicholas J. Nissing, St. Charles, MO (US); Gary J. Klopf, Grover, MO (US); John L. Vicini, Clarkson Valley, MO (US)

(73) Assignee: MONSANTO TECHNOLOGY LLC, St. Louis, MO (US)

(21) Appl. No.: 13/512,663

(22) PCT Filed: Nov. 30, 2010
(86) PCT No.: PCT/US10/58297

§ 371 Date: Jul. 30, 2012

Related U.S. Application Data
(60) Provisional application No. 61/265,191, filed on Nov. 30, 2009.
(60) Provisional application No. 61/285,028, filed on Dec. 9, 2009.

(51) Int. Cl. A23K 1/18; A23K 1/17; A23K 1/175; A23K 1/16

(52) U.S. Cl. 426/2; 426/635; 426/62; 426/72; 426/532

(57) ABSTRACT

The present disclosure provides for improved ruminant products and methods of producing such products by incorporating healthy lipids containing stearidonic acid into the ruminant feed for feeding ruminant animals. In one embodiment of the disclosure, an edible ruminant product including SDA is disclosed. In another embodiment, a reproductive ruminant product including SDA is disclosed.

### FIELD OF THE DISCLOSURE

The disclosure relates to the enhancement of desirable characteristics in ruminant (i.e., bovine, ovine, caprine) animals and ruminant products through the incorporation of beneficial fatty acids. More specifically, it relates to ruminant products and methods of production for ruminant products such as dairy products and meat products comprising polyunsaturated fatty acids including stearidonic acid.

### BACKGROUND OF THE DISCLOSURE

The present disclosure is directed to ruminant products such as dairy products and meat products including stearidonic acid (“SDA”) or SDA-enriched oil. Additionally, the present disclosure is directed to methods of enhancing desirable characteristics in ruminant animals and ruminant products by incorporating SDA into the diets of the animals.

Many studies have made a physiological link between dietary fats and pathologies such as obesity and atherosclerosis. In some instances, consumption of fats has been discouraged by the medical establishment. More recently, the qualitative differences between certain dietary fats and their health benefits have been recognized.

Recent studies have determined that despite their relatively simple biological structures, there are some types of fats that appear to improve body function in some ways. Some fats may, in fact, be essential to certain physiological processes. For example, it has been found that consumption of some fats can reduce the risk of cardiovascular disease in humans. The wider class of fat molecules includes triglycerides, isoprenols, phospholipids, steroids, other lipids and oil-soluble vitamins. Among these fat molecules are the fatty acids. The fatty acids are carboxylic acids, which have from 2 to 26 carbon atoms in their “backbone,” with none or some desaturated sites in their carbohydrate structure. They generally have dissociation constants (pKa) of about 4.5 indicating that in normal body conditions (physiological pH of 7.4) the vast majority of the free fatty acids will be in a dissociated form.

With continued experimentation, workers in the field have begun to understand the nutritional need for certain fats and in particular certain fatty acids in the diet. For this reason, many in the food industry have begun to focus on fatty acids and lipid technology as a new focus for food production, with its consequent benefits for the consumers consuming the modified products. This focus has been particularly true for the production and incorporation of omega-3 fatty acids into the diet. Omega-3 fatty acids are long-chain polyunsaturated fatty acids (18-22 carbon atoms in chain length) (LC-PUFAs) with the first of the double bonds (“unsaturations”) beginning with the third carbon atom from the methyl end of the molecule. They are called “polyunsaturated” because their molecules have at least two double bonds (unsaturations) in their carbohydrate chain. They are termed “long-chain” fatty acids since their carbon backbone has at least 18 carbon atoms.

In addition to stearidonic acid (SDA), the omega-3 family of fatty acids includes alpha-linolenic acid (“ALA”), eicosatetraenoic acid (ETA), eicosapentaenoic acid (“EPA”), docosapentaenoic acid (DPA), and docosahexaenoic acid (“DHA”). ALA can be considered a “base” omega-3 fatty acid, from which EPA and DHA are synthesized in the body through a series of enzymatic reactions, including the production of SDA. Most nutritionists point to DHA and EPA as the most physiologically important of the omega-3 fatty acids with the most beneficial effects due to the reduced incidence of cardiac disease that has been obtained from supplementation with fish oil. However, SDA has also been shown to have significant health benefits. See for example, U.S. Pat. No. 7,163,960 herein incorporated by reference. Furthermore, it has now been shown that SDA readily enriches the EPA level in red blood cells.

The synthesis process from ALA is by elongation (i.e., the molecule becomes longer by the addition of two carbon atoms) and “desaturation” (i.e., new double bonds are created), respectively. In nature, ALA is primarily found in certain plant leaves and seeds (e.g., flax) while EPA and DHA mostly occur in the tissues of cold-water predatory fish (e.g., tuna, trout, sardines and salmon), which they ingest from marine algae or microbes that they feed upon.

While there is a movement for food companies to develop and deliver essential fats and oils as an important component in a healthy human diet, and governments have begun developing regulations pushing for the adoption of PUFAs in the diet, there has been difficulty in supplying these needs as there has been an inability to develop a large enough supply of oil containing the beneficial forms of omega-3 to meet growing marketplace demand. Therefore, human consumption of ruminant products such as milk and cheese suffers from a lack of PUFAs which might otherwise deliver needed beneficial fatty acids to the human diet.

In addition to difficulties with simply securing an appropriate supply of LC-PUFAs for societal consumption, often the cost to process LC-PUFAs into food products is restrictive. These omega-3 fatty acids, and some of the other LC-PUFAs can be quickly oxidized leading to undesirable odors and flavors. More particularly, as already mentioned, the omega-3 fatty acids commercially deemed to be of highest value, EPA and DHA, which are provided in marine sources, also chemically oxidize very quickly over time limiting commercial availability. During the rapid process of EPA and DHA degradation these long-chain polyunsaturated fatty acids develop rancid and profoundly unsatisfactory sensory properties (e.g., fishy odor and taste) that make their inclusion in many foodstuffs or products difficult or impossible from a commercial acceptance perspective. To reduce the rate of oxidation, food processors must either distribute the oil in a frozen condition, add antioxidants/stabilizers, or encapsulate the desirable fatty acids, each greatly increasing the cost of processing and consequent cost to the consumer.

Furthermore, attempts at incorporating traditional omega-3 fatty acids such as alpha-linolenic acid (ALA) are not practical as these fatty acids are not efficiently converted to the beneficial forms. Nutritional studies have shown that, compared to ALA, SDA is 3 to 4 times more efficiently converted in vivo to EPA in humans (Ursin, 2003).

These limitations on supply, stability and sourcing greatly increase cost and correspondingly limit the availability of dietary omega-3 fatty acids. Accordingly, a need exists to enhance the nutritional quality of ruminant products, and in particular, edible ruminant products such as dairy products and meat products. The SDA-containing ruminant products of the current disclosure not only provide needed dietary fat for specific consumers, but also provide other dietary improvements for the commercial production of ruminant products.

In addition, a need exists to provide a consumer-acceptable means of delivering EPA and DHA or critical precursors in ruminant products in a commercially acceptable way. The current disclosure provides an alternative to fish or microbe-supplied omega-3 fatty acids in the form of ruminant products comprising beneficial omega-3 fatty acids and does so utilizing a comparatively chemically stable omega-3 fatty acid, SDA, as a source that offers improved cost-effective production and abundant supply as derived from transgenic plants.

### SUMMARY OF THE DISCLOSURE

The present disclosure includes the incorporation of oil from transgenic plants engineered to contain significant quantities of stearidonic acid (18:4n-3) (SDA) for use in ruminant (i.e., bovine, caprine, ovine) feed to improve the fatty acid profile of ruminant animals and to improve the reproductive performance, and productivity of ruminant animals. Additionally, ruminant products derived from the ruminant animals have an improved fatty acid profile, thereby providing improved health benefits to the end consumer.

The inventors have found that feeding cattle and other ruminant animals the SDA-containing ruminant feed of the present disclosure from transgenic plant sources is highly effective in increasing the omega-3 fatty acid levels of SDA (18:4), ETA (omega-3 20:4), and EPA (eicosapentaenoic acid), while acting to actually decrease the levels of the omega-6 fatty acids, AA (arachidonic acid), and docosatetraenoic acid (DTA, omega-6 22:4), thus, improving the omega-6 to omega-3 fatty acid ratio as compared to feeding vegetable oils such as soybean oil to such animals. This activity may improve the reproduction profile of ruminant animals, increasing their productivity, and improving their tissues for the production of ruminant products for human use or consumption, especially in species which require long chain PUFA's in their diets. Furthermore, according to embodiments of the current disclosure, the SDA-enriched oils used in the feed provide enhanced nutritional quality relative to traditional omega-3 alternatives such as flaxseed and lack negative taste and low stability characteristics associated with fish oil. Therefore, a preferred embodiment of this disclosure includes a ruminant feed with an increased level of beneficial polyunsaturated fatty acids such as SDA. The ruminant feed includes at least about 0.05% by weight SDA. Additionally, the ruminant feed includes at least about 0.03% by weight gamma linolenic acid (GLA). The ratio of SDA/GLA of the ruminant feed is at least about 1.3.

In another embodiment of the disclosure, a method of feeding the ruminant feed to a ruminant animal is provided. Particularly, the method includes: providing a ruminant feed; and feeding the ruminant feed to a plurality of ruminant animals. In one embodiment, the ruminant feed includes at least about 0.05% by weight SDA, at least about 0.03% by weight GLA, and has a ratio of SDA/GLA of at least about 1.3. In one particular embodiment, the plurality of ruminant animals includes a plurality of animals.

In another embodiment of the disclosure, the methods of improving the reproductive performance of ruminant animals are disclosed. In one embodiment, these methods include feeding ruminant animal feed comprising SDA. Improvement in the reproductive performance of the ruminant animals may include an increase in the percent of live births; an increase in the rate of conception, a decrease in early embryonic loss, or a decrease in days open.

The present disclosure is further directed to ruminant products. In one embodiment of the disclosure, a ruminant product including SDA, GLA, and eicosapentaenoic acid (EPA) is provided. Particularly, the ruminant product includes a concentration of SDA of at least about 1.0 g per 100 g fatty acids, a concentration of GLA of at least about 0.5 g per 100 g fatty acids, and a concentration of EPA of at least about 0.1 g per 100 g fatty acids. In one embodiment, the ruminant product is an edible ruminant product. In another embodiment, the ruminant product is a reproductive ruminant product.

In another embodiment of the disclosure, an edible ruminant product is provided. The edible ruminant product includes SDA and GLA, wherein the SDA is present in a concentration of at least about 15 mg per 100 g serving of the edible ruminant product.

Furthermore, methods of making the edible ruminant products as described above are disclosed. These methods may include providing a stearidonic acid source comprising SDA; providing a fatty acid protection agent whereby the fatty acid (e.g., SDA) is protected from ruminal biohydrogenation; providing additional feed components; contacting the stearidonic acid source coated, mixed or encapsulated in the protective agent or as a seed with the feed components to make a supplemented feed; feeding the supplemented feed to a plurality of ruminant animals; and harvesting at least one edible ruminant product from the ruminant animals. At least a portion of the SDA is incorporated into the edible ruminant product. In some embodiments, the SDA is incorporated into the edible ruminant product in a concentration of at least about 15 mg per 100 g serving of the edible ruminant product.

Exemplary stearidonic acid sources for obtaining the SDA and/or SDA-enriched oil may include transgenic soybeans, transgenic soybean oil, transgenic canola, transgenic canola oil, transgenic corn, transgenic corn oil, echium, and echium oil. Additional stearidonic acid sources may include seeds such as soybeans, safflower, canola, echium and corn.

The amount of SDA in the enriched oil may vary due to germplasm, environmental effects, and the like. In at least one embodiment, the SDA-enriched oil includes from about 1% (by weight) to about 60% (by weight) of SDA. In another embodiment, the SDA-enriched oil includes from about 10% (by weight) to about 30% (by weight) of SDA. In an even more particularly preferred embodiment, the SDA-enriched oil includes about 20% (by weight) SDA.

In at least one embodiment, the ruminant product including SDA includes at least about 15 mg SDA in a 100 gram serving of the edible ruminant product, more suitably, at least about 50 mg SDA in a 100 gram serving of the edible ruminant product, even more suitably, at least about 100 mg SDA in a 100 gram serving of the edible ruminant product, and even more suitably, at least about 150 mg SDA in a 100 gram serving of the edible ruminant product. This amount ensures providing the end consumer with the minimum amount of SDA per day needed to enrich EPA in tissues based on James, et al. (2003).

Other features and advantages of this disclosure will become apparent in the following detailed description of preferred embodiments of this disclosure, taken with reference to the accompanying figures.

### BRIEF DESCRIPTION OF THE FIGURE

FIG. 1 depicts the SDA concentration in milk produced by dairy cows supplemented with SDA-enriched oil as measured in Example 1.

### DEFINITIONS

The following definitions are provided to aid those skilled in the art to more readily understand and appreciate the full scope of the present disclosure. Nevertheless, as indicated in the definitions provided below, the definitions provided are not intended to be exclusive, unless so indicated. Rather, they are preferred definitions, provided to focus the skilled artisan on various illustrative embodiments of the disclosure.

As used herein the term “ruminant product” refers to food or edible products, as well as reproductive products, comprising tissue or cells from a ruminant animal (i.e., bovine, caprine, ovine). Examples of edible ruminant products include milk, meat, cheese, butter, cultured milk products (yoghurt), cream, and the like. Exemplary reproductive ruminant products include semen, unfertilized ruminant eggs, and embryos (i.e., fertilized eggs). Still other ruminant products include products such as leather.

As used herein, the term “ruminant meat product” refers to food or edible products comprising at least a portion of meat from a ruminant animal.

As used herein, the terms “ruminant” or “ruminant animal” refer to any species of the family Bovidae, which includes the subfamilies Bovinae and Caprinae. Exemplary ruminant animals include, but are not limited to cattle, bison, water buffalo, yak, antelope, goats, and sheep.

As used herein, the term “reproductive performance” refers to a measure of an animal or herd's productivity with respect to improved reproduction and rate of development of progeny. Measures of reproductive performance may include rate of conception, percent live births, early embryonic death, and days open (i.e., days the animal is not pregnant).

As used herein, the term “SDA-enriched oil” refers to an oil including at least about 10% (by weight) SDA.

### DETAILED DESCRIPTION OF THE DISCLOSURE

### Production of SDA:

The present disclosure relates to a system for an improved method for the plant based production of stearidonic acid and its incorporation into the diets of humans in an effort to improve human health. This production is made possible through the utilization of transgenic plants engineered to produce SDA in sufficiently high yield so as to allow commercial incorporation into food products. For the purposes of the current disclosure the acid and salt forms of fatty acids, for instance, butyric acid and butyrate, arachidonic acid and arachidonate, will be considered interchangeable chemical forms.

All higher plants have the ability to synthesize the main 18 carbon PUFAs, LA and ALA, and in some cases SDA (C18:4n3, SDA), but few are able to further elongate and desaturate these to produce arachidonic acid (AA), EPA or DHA. Synthesis of EPA and/or DHA in higher plants therefore requires the introduction of several genes encoding all of the biosynthetic enzymes required to convert LA into AA, or ALA into EPA and DHA. Taking into account the importance of PUFAs in human health, the successful production of PUFAs (especially the n-3 class) in transgenic oilseeds, according to the current disclosure can then provide a sustainable source of these essential fatty acids for dietary use. The “conventional” aerobic pathway which operates in most PUFA-synthesizing eukaryotic organisms, starts with Δ6 desaturation of both LA and ALA to yield γ-linolenic (GLA, 18:3n6) and SDA, respectively.

Turning to Table 1, it is important to provide a basis of what constitutes “normal” ranges of oil composition vis-à-vis the oil compositions used in the ruminant feed and ruminant products of the current disclosure. A significant source of data used to establish basic composition criteria for edible oils and fats of major importance has been the Ministry of Agriculture, Fisheries and Food (MAFF) and the Federation of Oils, Seeds and Fats Associations (FOSFA) at the Leatherhead Food International facility in the United Kingdom.

To establish meaningful standards data, it is preferred that sufficient samples be collected from representative geographical origins and that these oils are pure. In the MAFF/FOSFA work, over 600 authentic commercial samples of vegetable oilseeds of known origin and history, generally of ten different geographical origins, were studied for each of 11 vegetable oils. The extracted oils were analyzed to determine their overall fatty acid composition (“FAC”). The FAC at the 2-position of the triglyceride, sterol and tocopherol composition, triglyceride carbon number and iodine value, protein values in the oil, melting point and solid fat content as appropriate are determined.

Prior to 1981, FAC data were not included in published standards because data of sufficient quality were not available. In 1981, standards were adopted that included FAC ranges as mandatory compositional criteria. The MAFF/FOSFA work provided the basis for later revisions to these ranges.

In general, as more data became available, it was possible to propose fatty acid ranges much narrower and consequently more specific than those adopted in 1981. Table 1 gives examples of FAC of oils that were adopted by the Codex Alimentarius Commission (CAC) in 1981 and ranges for the same oils proposed at the Codex Committee on Fats and Oils (CCFO) meeting held in 1993.

TABLE 1
Standards For Fatty Acid Composition Of Oils (% Of Oil)

| | | | Arachis | | | |
|---|---|---|---|---|---|---|
| | Soyabean | Sunflowerseed | (peanut) | Coconut | Maize | |
| Fatty acid | oil | oil | oil | oil | oil | Palm oil |
| C6:0 | ND | ND | ND | ND-0.7 | ND | ND |
| C8:0 | ND | ND | ND | 4.6-10.0 | ND | ND |
| C10:0 | ND | ND | ND | 5.0-8.0 | ND | ND |
| C12:0 | ND-0.1 | ND-0.1 | ND-0.1 | 45.1 53.2 | ND-0.3 | ND-0.5 |
| C14:0 | ND-0.2 | ND-0.2 | ND-0.1 | 16.8-21.0 | ND-0.3 | 0.5-2.0 |
| C16:0 | 8.0-13.5 | 5.0-7.6 | 8.0-14.0 | 7.5-10.2 | 8.6-16.5 | 39.3-47.5 |
| C16:1 | ND-0.2 | ND-0.3 | ND-0.2 | ND | ND-0.5 | ND-0.6 |
| C17:0 | ND-0.1 | ND-0.2 | ND-0.1 | ND | ND-0.1 | ND-0.2 |
| C17:1 | ND-0.1 | ND-0.1 | ND-0.1 | ND | ND-0.1 | ND |
| C18:0 | 2.0-5.4 | 2.7-6.5 | 1.0-4.5 | 2.0-4.0 | ND-3.3 | 3.5-6.0 |
| C18:1 | 17-30 | 14.0-39.4 | 35.0-69 | 5.0-10.0 | 20.0-42.2 | 36.0-44.0 |
| C18:2 | 48.0-59.0 | 48.3-74.0 | 12.0-43.0 | 1.0-2.5 | 34.0-65.6 | 9.0-12.0 |
| C18:3 | 4.5-11.0 | ND-0.3 | ND-0.3 | ND-0.2 | ND-2.0 | ND-0.5 |
| C20:0 | 0.1-0.6 | 0.1-0.5 | 1.0-2.0 | ND-0.2 | 0.3-1.0 | ND-1.0 |
| C20:1 | ND-0.5 | ND-0.3 | 0.7-1.7 | ND-0.2 | 0.2-0.6 | ND-0.4 |
| C20:2 | ND-0.1 | ND | ND | ND | ND-0.1 | ND |
| C22:0 | ND-0.7 | 0.3-1.5 | 1.5-4.5 | ND | ND-0.5 | ND-0.2 |
| C22:1 | ND-0.3 | ND-0.3 | ND-0.3 | ND | ND-0.3 | ND |
| C22:2 | ND | ND-0.3 | ND | ND | ND | ND |
| C24:0 | ND-0.5 | ND-0.5 | 0.5-2.5 | ND | ND-0.5 | ND |
| C24:1 | ND | ND | ND-0.3 | ND | ND | ND |

Source: Codex Alimentarius Commission, 1983 and 1993.

More recently, oils from transgenic plants have been created. Some embodiments of the present disclosure may incorporate products of transgenic plants such as transgenic soybean oil. Transgenic plants and methods for creating such transgenic plants can be found in the literature. See for example, WO2005/021761A1. As shown in Table 2, the composition of the transgenic soy oil is substantially different than that of the accepted standards for soy oil.

TABLE 2
A comparison of transgenic soy oil and traditional
soy oil fatty acid compositions (% of Oil)

| | Low SDA | Medium SDA | High SDA |
|---|---|---|---|
| | Soy Oil | Soy Oil | Soy Oil |
| C14:0 (Myristic) | 0.10 | 0.10 | 0.10 |
| C16:0 (Palmitic)) | 12.13 | 12.3 | 12.5 |
| C16:1 (Palmitoleic) | 0.1 | 0.1 | 0.1 |
| C18:0 (Stearic) | 4.2 | 4.6 | 4.2 |
| C18:1 (Oleic) | 19.4 | 18.7 | 16.0 |
| C18:2 (Linoleic) | 35.3 | 23.9 | 18.5 |
| C18:3 n6 (Gamma Linolenic) | 4.9 | 6.4 | 7.2 |
| C18:3 n3 (Alpha-Linolenic) | 10.1 | 10.8 | 10.3 |
| C18:4 n3 (Stearidonic) | 11.4 | 20.5 | 28.0 |
| C20:0 (Arachidic) | 0.4 | 0.4 | 0.4 |
| C20:1 (Eicosenoic) | 0.4 | 0.2 | 0.3 |
| C22:0 (Behenic) | 0.4 | 0.3 | 0.3 |
| C24:0 (Lignoceric) | 0.1 | 0.1 | 0.1 |
| Other fatty acids | <3 | <3 | <3 |

According to embodiments of the current disclosure, the preferred plant species that could be modified to reasonably supply demand are: soybeans, canola, corn, and echium but many other plants could also be included as needed and as scientifically practicable. For the present disclosure, the preferred source of SDA is transgenic soybeans which have been engineered to produce high levels of SDA. The soybeans may be processed at an oil processing facility and oil may be extracted consistent with the methods described in US Patent Applications 2006/0111578A1, 2006/0110521A1, and 2006/0111254A1.

It should be recognized that once produced, the SDA of the disclosure can be used to improve the health and reproductive performance of ruminant animals as well as the health characteristics of resulting ruminant products. This production offers a sustainable crop-based source of omega-3 fatty acids that enriches EPA in red blood cells and other tissues, and has improved flavor and stability as compared to many alternative omega-3 fatty acid sources available today.

### Ruminant Feeds:

As noted above, the ruminant feeds of the present disclosure include SDA, and more particularly, in one or more embodiments, the feeds include SDA from an SDA-enriched oil. Typically, the ruminant feeds include at least about 0.05% by weight SDA, more suitably, at least about 0.2% by weight SDA, even more suitably, at least about 0.8% by weight SDA, even more suitably, at least about 1% by weight SDA, even more suitably, at least about 2% by weight SDA, even more suitably, at least about 4% by weight SDA, even more suitably, at least about 4% by weight SDA and less than about 6% by weight SDA.

The source of added SDA can be synthetic or natural. The natural stearidonic acid is sourced from a grain or marine oils or from oils from the group consisting of palm oil, sunflower oil, safflower oil, cottonseed oil, canola oil, corn oil, soybean oil, flax oil, and echium oil. The natural stearidonic acid in the grain or oilseed is genetically modified to an elevated level in such grain or oil as compared to the levels of stearidonic acid found in the native grain or oil.

The SDA may be incorporated in the feed in the form of a whole seed, ground seed, extruded seed, extracted oil, triglyceride, or esters and the oil coated, mixed or encapsulated with an agent to protect against biohydrogenation in the rumen. The form of SDA may be incorporated into the ruminant feed and fed as a meal, crumble, pellet, sprayed on a pellet, or vacuum coated in the pellet.

In addition to SDA, the stearidonic acid source may include other beneficial polyunsaturated fatty acids in addition to SDA. Specifically, the stearidonic acid source may be used to produce ruminant feed that includes increased levels of other beneficial polyunsaturated fatty acids such as GLA, alpha-linolenic acid (ALA), linoleic acid (LA), DGLA, EPA, ETA, and combinations thereof. For example, in one embodiment, the ruminant feed includes at least about 0.03% by weight GLA, and the feed includes a ratio of SDA/GLA of at least about 1.3, at least about 1.5, and even more suitably at least about 2.0. More suitably, the ruminant feed includes a ratio of SDA/GLA of from about 1.3 to about 6.0, and even more suitably, from about 2.0 to about 4.0. For example, in one particular embodiment, the ruminant feed includes GLA, wherein GLA is present in a concentration of at least about 0.4 g per 100 grams, and more suitably, about 1.0 g per 100 grams total fatty acid in the feed.

In another embodiment, the ruminant feed further includes LA. In one particularly preferred embodiment, the ruminant feed includes SDA, GLA, and LA, wherein the ratio of concentrations of GLA/LA is at least about 0.02. More suitably, the ratio of concentrations of GLA/LA in the ruminant feed is at least about 0.1, more suitably, at least about 0.15, more suitably, at least about 0.20, and even more suitably, at least about 0.25.

In another embodiment, the ruminant feed further includes ALA. In a particularly preferred embodiment, the ruminant feed includes a ratio of SDA/ALA of at least about 0.1. In yet another preferred embodiment, the ruminant feed includes ALA in a concentration of at least about 0.5% by weight.

In another embodiment, the ruminant feed further includes dihomo-gamma-linolenic acid (DGLA). In a particularly preferred embodiment, the ruminant feed includes DGLA in a concentration of at least about 0.001% by weight.

Typically, while the ruminant feed may include one or more of any of the above described polyunsaturated fatty acids in addition to SDA, it should be understood that in one or more preferred embodiments, the stearidonic acid source used for producing the ruminant feed comprises amounts of omega-6 fatty acids and omega-3 fatty acids in a ratio of omega-6:omega-3 of greater than about 1:3.

Additionally, the stearidonic acid source may include additional ingredients for the ruminant feed. For example, in one embodiment, the stearidonic acid source may include 6-cis,9-cis,12-cis,15-trans-octadecatetraenoic acid. Typically, when included, the stearidonic acid source includes 6-cis,9-cis,12-cis,15-trans-octadecatetraenoic acid in an amount of at least about 0.01% by weight.

In another embodiment, the stearidonic acid source may include 9-cis,12-cis,15-trans-alpha linolenic acid. Typically, when included, the stearidonic acid source includes 9-cis,12-cis,15-trans-alpha linolenic acid in an amount of at least about 0.01% by weight.

In another embodiment, the stearidonic acid source may include 6,9-octadecadienoic acid. Typically, when included, the stearidonic acid source includes 6,9-octadecadienoic acid in an amount of at least about 0.01% by weight.

In yet another embodiment, the stearidonic acid source may include tocochromanol. Typically, when included, the stearidonic acid source includes tocochromanol in an amount of at least about 10 ppm. In one particularly preferred embodiment, the stearidonic acid source includes tocopherol as the tocochromanol.

The SDA (and any other polyunsaturated fatty acids present in the stearidonic acid source) may be contacted with additional feed ingredients to provide a supplemented feed. Exemplary additional feed ingredients may include ingredients such as grains (i.e., corn, wheat, barley), oilseed meals (i.e., soybean meal, cottonseed meal, flaxseed meal, canola meal), byproducts (i.e., wheat middlings, wheat bran, rice bran, corn distiller dried grains, brewers grains, corn gluten meal, corn gluten feed, molasses, rice mill byproduct), milk products (i.e., casein, whey proteins), oils (i.e., corn oil, flax oil, soy oil, palm oil, animal fat, fish oil, restaurant grease, and blends thereof), vitamin and minerals, amino acids, antioxidants, tocochromanols, tocopherols, coccidostats, feed additives, yeasts, buffers (i.e., sodium bicarbonate, calcium carbonate, magnesium hydroxide), organic acids (i.e., propionic acids, acetic acids, blends thereof), mycotoxin inhibitors, clays, alumina, and the like, and combinations thereof.

In some embodiments, the ruminant feed may include oils in addition to the SDA-enriched oil in the feed as energy sources. Exemplary of these additional oils include animal fats, hydrogenated or partially hydrogenated or nonhydrogenated soybean oil, canola oil, rapeseed oil, corn oil, cottonseed oil, linseed oil, coconut oil, restaurant grease, walnut oil, or palm oil with the ground, roasted nuts and SDA-enriched oil and combinations thereof.

Typically, the feed includes these supplemental oils in amounts of from about 0% (by weight) to about 2.5% (by weight). More particularly, the feed may include these oils in amounts of from about 0.3% (by weight) to about 3.0% (by weight). In one particularly preferred embodiment, the feed includes these stabilizing oils in an amount of about 1.2% (by weight). The total fat in the diet is not to exceed about 8.0% (by weight).

In some embodiments, agents for protecting the SDA oil from biohydrogenation in the rumen may be used (see Papas and Wu, 1997). These include mixtures of ruminally undegradable proteins (see e.g., mixtures disclosed in U.S. Pat. No. 5,932,257 to University of Guelph (Aug. 3, 1999), which is hereby incorporated by reference to the extent it is consistent herewith), whey protein gel complexes (see e.g., complexes disclosed in U.S. Patent Application No. 2004/0058003 (Mar. 25, 2004), which is hereby incorporated by reference to the extent it is consistent herewith), protein coatings or encapsulation (e.g., lignin sulfonates and polymeric substances as disclosed in U.S. Pat. No. 4,595,584 to Eastman Kodak Company (Jun. 17, 1986); emulsified liquids as disclosed in U.S. Pat. No. 6,835,397 to Balchem Corporation (Dec. 28, 2004) and U.S. Pat. No. 5,874,102 LaJoie, et al. (Feb. 23, 1999), which are hereby incorporated by reference to the extent they are consistent herewith).

### Methods of Feeding Ruminant Animals:

Additionally, the present disclosure is directed to methods of feeding ruminant animals the ruminant feed as described above to produce ruminant animals having an improved omega-3 fatty acid profile, thereby improving the health and reproduction of the ruminant animals. Embodiments of the present disclosure may incorporate any methods known in the art for feeding ruminant animals. The SDA oil should be protected against ruminal biohydrogenation as described above. Examples of techniques which may be useful in embodiments of the present disclosure include: (a) mixed in a complete feed; (b) mixed in a grain portion of a complete feed; (c) mixed in a mineral or vitamin supplement component of an animal's feed; (d) mixed in a protein supplement of an animal's feed; (e) topped dressed on the forage, total mixed diet, or grain portion; (f) added to a liquid supplement of an animal's feed. In one embodiment, the ruminant animals to be fed are of the family Bovidae. All ruminants such as dairy cattle, beef cattle, water buffalo, goats, and sheep can be fed with the ruminant feed of the present disclosure.

In order to attain the desired concentration of SDA and other fatty acids in the ruminant products described below, different combinations of dietary concentrations of SDA in the feed and duration of feeding the SDA may be employed. In some embodiments, fish oil is blended with vegetable oil comprising SDA to make a blended oil. The SDA content of the SDA/fish oil blend may be in excess of 0.1%, 0.2%, 0.4%, 0.6%, 0.8%, 1.0%, 2.0%, 3.0%, or 4.0% by weight of the oil. In some embodiments, the concentration of SDA in the blended oil may be as high as 5%, 10%, 15%, 20%, 25%, or even 30% by weight of the blended oil. In some embodiments of the disclosure, the ruminant animal, such as cattle, goats, and sheep may be fed for periods of as little as 1 day. In preferred embodiments, ruminant animals are fed on multiple occasions over multiple days. In preferred embodiments, ruminant animals are fed feed containing SDA from a vegetable based source over a period of at least about 7 days, 21 days, 30 days, 60 days, 90 days, 120 days, 150 days or even 305 days or more.

Furthermore, in some embodiments, the amount of SDA in the feed may be altered depending on the reproductive status of the animal and/or the desired level of SDA in the ruminant product. In ruminant meat production, for example, additional SDA may be incorporated into the feed near the later stages of development to maximize the deposition in the meat tissues. In some embodiments, SDA may also be increased to improve reproductive performance.

These unique compositions and fatty acid ratios are expected to provide unique dairy and meat products such as milk, cheese, butter, cultured milk (e.g., yoghurt), cream, and meat which also have unique characteristics. Benefits of consuming these unique fatty acids are expected to propagate through the food chain such that initial benefits may be to the ruminant animal, but secondary benefits are accrued upon human consumption of ruminant products derived from the animal.

### Ruminant Products and Methods of Producing Ruminant Products:

Once the ruminant feed is produced, ruminant products harvested from the ruminant animals fed the ruminant feed are prepared. Generally, the method of producing the ruminant products includes: providing a stearidonic acid source comprising SDA; providing additional feed components; contacting the stearidonic acid source, optionally protected against biohydrogenation with a protecting agent with the feed components to make a supplemented feed; feeding the supplemented feed to a plurality of ruminant animals; and harvesting at least one ruminant product from the ruminant animals. More specifically, a ruminant product can be harvested from the ruminant animals in such a manner so as to include at least a portion of the SDA in the ruminant product. Embodiments of the present disclosure may incorporate any methods known in the art of cattle farming techniques, as well as production and harvesting methods for producing dairy and meat products.

Typically, in one or more embodiments, the ruminant product may include SDA in a concentration of at least about 0.5 g per 100 g of total fatty acid. More suitably, the ruminant product includes SDA in a concentration of at least about 0.5 g per 100 g of total fatty acids, more suitably, in a concentration of at least about 1.0 g per 100 g of total fatty acid, more suitably, in a concentration of at least about 2.0 g per 100 g of total fatty acid, more suitably, in a concentration of at least about 4.0 g per 100 g of total fatty acid, and even more suitably, in a concentration of at least about 8.0 g per 100 g of total fatty acid. In another embodiment, the ruminant product includes SDA in an amount of about 15 mg per 100 g serving of the ruminant product. More suitably, the ruminant product includes SDA in an amount of about 60 mg per 100 g serving, more suitably, in an amount of about 120 mg per 100 g serving, and even more suitably, in an amount of about 200 mg per 100 gram serving.

In one embodiment, the ruminant product is an edible ruminant product such as a dairy product or a meat product. Dairy products that can be produced include milk, cheese, butter, cultured milk products, cream, and combinations thereof.

In another embodiment, the ruminant product is a reproductive product including reproductive material. Several reviews have been written that dealt with the role of the omega-3 (n-3) long polyunsaturated fatty acids (LC-PUFA), EPA and DHA, and the reproduction. LC-PUFA such as EPA and DHA has been shown to improve reproduction of ruminants by effects on ovulation, uterine environment, semen quality and/or embryo quality. Specifically, it has been found that feeding EPA and DHA has resulted in increases in caruncular tissue and endometrial tissue suggesting uptake of these fatty acids into the cell membranes, thereby improving reproductive performance, decreased embryonic loss, and increased gestation length (see e.g., Palmquist, 2009; Thatcher, et al., 2006; and Wathes, et al., 2007). SDA has been shown to increase concentrations of EPA in red blood cell membranes and this is evidence of SDA metabolism to the longer-chain PUFA. Furthermore, feeding DHA to boars increases DHA content of spermatozoa phospholipids and oocyte PUFA content can affect maturation. Accordingly, it is hypothesized that including SDA in the ruminant feeds of the present disclosure should increase membrane content of EPA in spermatozoa and oocytes, improving ruminant reproduction.

In one embodiment, the reproductive material is semen. In another embodiment, the reproductive material is an unfertilized ruminant egg. In another embodiment, the reproductive material is the embryo or fertilized egg.

As noted above, in some embodiments, the ruminant product can be harvested such as to include other beneficial polyunsaturated fatty acids. For example, in one or more embodiments, the ruminant product may include fatty acids such as GLA, EPA, DHA, DGLA, and combinations thereof. In one or more embodiments, the ruminant product may include GLA in a concentration of at least about 0.25 g per 100 g of total fatty acid. More suitably, the ruminant product includes GLA in a concentration of at least about 0.5 g per 100 g of total fatty acid, and even more suitably, in a concentration of at least about 5.0 g per 100 g of total fatty acid. In another embodiment, the ruminant product includes GLA in an amount of about 7.0 mg per 100 g serving of the ruminant product. More suitably, the ruminant product includes GLA in an amount of about 20 mg per 100 g serving, and even more suitably, in an amount of about 100 mg per 100 gram serving.

In one or more embodiments, the ruminant product may include EPA in a concentration of at least about 50 mg per 100 g of total fatty acid. More suitably, the ruminant product includes EPA in a concentration of at least about 10 mg per 100 g of total fatty acid, and even more suitably, in a concentration of at least about 0.1 g per 100 g of total fatty acid.

Additionally, in one embodiment, the ruminant products may include additional components. For example, in one particularly preferred embodiment, the ruminant products may include tocochromanol. Typically, when included, the ruminant product includes at least about 10 ppm tocochromanol. In one particularly preferred embodiment, the ruminant product includes tocopherol as the tocochromanol.

### ILLUSTRATIVE EMBODIMENTS OF THE DISCLOSURE

The following examples are included to demonstrate general embodiments of the disclosure. It should be appreciated by those of skill in the art that the techniques disclosed in the examples which follow represent techniques discovered by the inventors to function well in the practice of the disclosure, and thus can be considered to constitute preferred modes for its practice. However, those of skill in the art should, in light of the present disclosure, appreciate that many changes can be made in the specific embodiments which are disclosed and still obtain a like or similar result without departing from the disclosure.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied without departing from the concept and scope of the disclosure.

In the examples below, transgenic soybean oil containing SDA is/was used. Similar results would be obtained when using oil derived from other transgenic plants such as corn or canola.

### Example 1

In this Example, transgenic soybean oil containing SDA was either infused directly in the rumen or directly into the abomasum bypassing the rumen to examine the potential of using SDA-enhanced soybean oil to increase the milk fat content of omega-3 fatty acids in dairy cows and to determine the efficiency of SDA uptake from the digestive tract and transfer to milk fat.

Three multiparous, pregnant, rumen-fistulated Holstein cows averaging 267 days in lactation were assigned randomly to a 3×3 Latin square design. Treatments were: 1) control (no oil infusion); 2) abomasal infusion of SDA-enhanced SBO (SDA-abo) and 3) ruminal infusion of SDA-enhanced SBO (SDA-rum). Oil infusions (210 g/d) provided 57 g/d of stearidonic acid and infusion periods were 7 d with a 7 d washout between periods.

Cows were housed in individual tie stalls at Cornell's Large Animal Research and Teaching Unit and fed ad libitum a dry diet. The forage was a mixture of alfalfa hay and grass hay, and the TMR was 50:50 forage:concentrate (90% DM, 17.6% CP, 40.6% NDF, 25% ADF, and 3.1% crude fat).

Cows were milked twice a day with two milk samples obtained at each milking. One milk sample was analyzed for major components (i.e., fat, protein, lactose) by infrared analysis. The second milk sample was analyzed for fatty acids with extraction, methylation and gas chromatographic analysis. Fatty acids were quantified using pure methyl ester standards and a butter oil reference standard was analyzed periodically to monitor column performance and correction factors for individual fatty acids. Identification of less common omega-3 milk fatty acids was confirmed using GC-Mass Spectrometry.

Statistical analyses were conducted using the PROC GLM procedure (Version 5, SAS Institute, Cary, N.C.). One cow suffered a physical injury and had to be removed from the study just prior to the start of her third period (abomasal infusion) resulting in a missing cell.

The SDA-enhanced soybean oil contained 27.1% SDA, 10.4% ALA and 7.3% γ-linolenic acid; relative to the typical fatty acid composition of SBO, these increases were offset mainly by a reduction in linoleic and oleic acids (Table 3).

TABLE 3
Major fatty acids in the stearidonic acid-enriched soybean oil

| | SDA-enhanced SBO¹ | Soybeans² |
|---|---|---|
| Fatty acid | Percent of total fatty acids | |
| Palmitic acid, 16:0 | 12.50 | 11.4 ± 1.9 |
| Stearic acid, 18:0 | 4.26 | 4.1 ± 0.6 |
| Oleic acid, 18:1 | 14.66 | 22.3 ± 2.5 |
| Linoleic acid, 18:2n − 6 | 18.42 | 53.5 ± 3.2 |
| γ-Linolenic acid, 18:3n − 6 | 7.25 | |
| α-Linolenic acid, 18:3n − 3 | 10.43 | [7.0 ± 1.9]³ |
| Stearidonic acid, 18:4n − 3 | 27.10 | |

¹Stearidonic acid-enhanced soybean oil.
²Values are mean ± SD of 44 soybean oil seed supplements as reported by Glasser et al. (2008).
³Reported as “linolenic acid”.

Infusion of the SDA-enhanced SBO into the rumen or abomasum had no effect on DMI or milk production; across treatments daily DMI and milk production averaged (least-squares mean±SE) 22.9±0.5 kg and 32.3±0.9 kg, respectively. Likewise, treatments did not differ in milk protein percent and yield (3.24±0.04% and 1.03±0.02 kg/d, respectively) or milk lactose percent and yield (4.88±0.05% and 1.55±0.05 kg/d, respectively). In the case of milk fat, yield was unaffected by treatment (1.36±0.03 kg/d), but milk fat percent was less (P<0.01) for the SDA-rumen treatment (4.04±0.04%) as compared to control (4.30±0.04%) and abomasal treatment (4.41±0.05%).

Examination of milk fatty acid composition revealed that many fatty acids were unchanged, but there were changes related to specific treatments. None of the individual saturated fatty acids differed among treatments (data not presented), and across treatments the saturated fatty acids represented 61.0±2.1% (least-squares mean±SE) of total milk fatty acids. Among the monounsaturated fatty acids, oleic acid was unaffected by treatment. However, consistent with rumen biohydrogenation of the infused PUFA, there were significant increases in the milk fat content of trans-18:1 isomers for the rumen infusion group (Table 4); generally these increases were of small magnitude with the largest occurring for vaccenic acid (trans-11 18:1) which approached 2% of total milk fatty acids. Vaccenic acid originates as an intermediate in rumen biohydrogenation of 18-carbon PUFA and it is converted to cis-9, trans-11 18:2 (conjugated linoleic acid; CLA) by the mammary enzyme 49 desaturase (Bauman et al., 2006); consistent with this, milk fat content of CLA was also increased for the SDA-rum treatment (Table 4).

TABLE 4
Partial listing of milk fatty acids and the effect of treatment

| | Treatment¹ | | | |
|---|---|---|---|---|
| | Control | SDA-abo | SDA-rum | |
| Fatty Acids | Percent of total milk fatty acids | | | P¹ |
| Oleic acid, 18:1, c9 | 25.09 ± 1.49 | 22.10 ± 1.97 | 26.03 ± 1.49 | NS |
| Trans fatty acids | | | | |
| 18:1, t6-8 | 0.27^{b} ± 0.01 | 0.20^{b} ± 0.02 | 0.35^{a} ± 0.01 | .02 |
| 18:1, t9 | 0.22^{b} ± 0.01 | 0.18^{b} ± 0.01 | 0.32^{a} ± 0.01 | .01 |
| 18:1, t10 | 0.37^{b} ± 0.01 | 0.34^{b} ± 0.02 | 0.48^{a} ± 0.01 | .02 |
| 18:1, t11 | 1.07^{b} ± 0.11 | 0.96^{b} ± 0.15 | 1.96^{a} ± 0.11 | .02 |
| 18:1, t12 | 0.38^{b} ± 0.03 | 0.25^{b} ± 0.04 | 0.60^{a} ± 0.03 | .01 |
| Linoleic acid, 18:2n − 6 | 3.30^{b} ± 0.20 | 5.81^{a} ± 0.26 | 2.96^{b} ± 0.20 | .01 |
| γ-Linolenic acid, 18:3n − 6 | 0.04^{b} ± 0.01 | 0.57^{a} ± 0.01 | 0.05^{b} ± 0.01 | .0001 |
| α-Linolenic acid, 18:3n − 3 | 0.44^{b} ± 0.02 | 1.55^{a} ± 0.03 | 0.43^{b} ± 0.02 | <.01 |
| Rumenic acid, c9, t11 18.2 | 0.45^{b} ± 0.03 | 0.31^{b} ± 0.05 | 0.70^{a} ± 0.03 | .01 |
| Stearidonic acid, 18:4n − 3 | <0.01^{b} | 1.86^{a} ± 0.02 | 0.07^{b} ± 0.02 | .0001 |
| Arachidonic acid, 20:4n − 6 | 0.17 ± 0.01 | 0.19 ± 0.01 | 0.15 ± 0.01 | NS |
| Eicosatetraenoic acid, 20:4n − 3 | 0.04^{b} ± <0.01 | 0.23^{a} ± <0.01 | 0.04^{b} ± <0.01 | .0001 |
| Eicosapentaenoic acid, 20:5n − 3 | 0.06^{b} ± 0.01 | 0.18^{a} ± 0.01 | 0.05^{b} ± 0.01 | .01 |
| Docosapentaenoic acid, 22:5n − 3 | 0.08 ± <0.01 | 0.08 ± <0.01 | 0.07 ± <0.01 | NS |
| Docosahexaenoic acid, 22:6n − 3 | <0.01 | <0.01 | <0.01 | NS |

¹Probability of significant difference among treatments. Within a row differences are indicated by different superscripts.
NS = nonsignificant at P > 0.1.

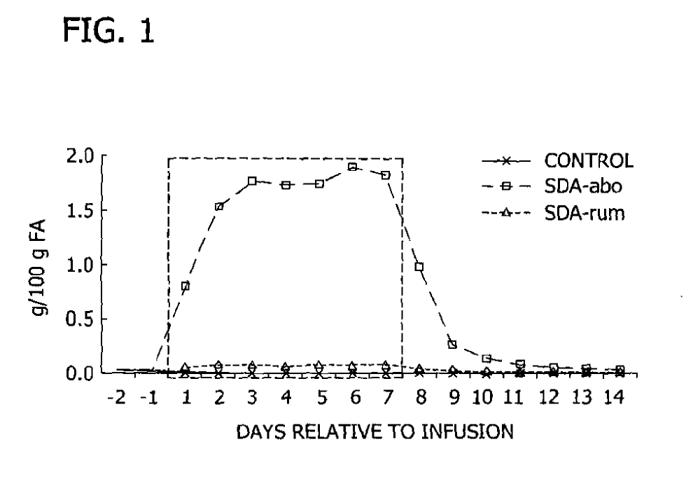

The SDA-abo treatment resulted in increases in the milk fat content of several PUFA (Table 4). Increases were specifically observed with ALA, SDA, eicosatetraenoic acid (ETA), and EPA. However, milk fat content of docosapentaenoic acid (DPA) and DHA did not differ among treatment groups (Table 4). For the SDA-abo treatment, the temporal patterns of ALA, SDA, ETA and EPA increased following the initiation of infusion reaching a plateau by d 3 and 4 of infusion (FIG. 1 SDA concentration in milk). Overall, the omega-3 content of milk fat was 3.9% of total milk fatty acids with the SDA-abo treatment, a value more than 600% greater than milk fat from the control group (Table 4). When abomasal infusion was terminated, milk fat content of these fatty acids progressively decreased to pre-infusion values following a mirror-image pattern of the increase. In contrast, rumen infusion had little or no effect on omega-3 fatty acids, and milk fatty acid values were similar to the control treatment (water infusion) (FIG. 1 and Table 4).

The transfer efficiency of SDA to milk fat represented 39.3% (range=36.8 to 41.9%) of the SDA present in the abomasally infused oil. If increases in the omega-3 fatty acids downstream from SDA are included, then the transfer efficiency for SDA increases to 47.3% (range=45.0 to 49.6%).

### REFERENCES

The references cited in this application, both above and below, are specifically incorporated herein by reference.
AOAC. 2000. Official Methods of Analysis. 17th ed. Assoc. Off. Anal. 289 Chem., Arlington, Va.
Arterburn, L. M., E Bailey Hall, and H. Oken. 2006. Distribution, interconversion, and dose response of n-3 fatty acids in humans. Am. J. Clin. Nutr. 83(suppl):1467S-293 1476S.
Bauman, D. E., and J. M. Griinari. 2001. Regulation and nutritional manipulation of milk fat: low-fat milk syndrome. Livestock Prod. Sci. 70:15-29.
Bauman, D. E., I. Mather, R. Wall, and A. L. Lock. 2006. Major advances associated with the biosynthesis of milk. J. Dairy Sci. 89:1235-1243.
Brenna, J. T., N. Salem Jr., A. J. Sinclair, and S. C. Cunnane. 2009. α-Linolenic acid supplementation and conversion to n-3 long-chain polyunsaturated fatty acids in humans. Prostglandins, Leukotrienes, and Essential Fatty Acids 80:85-91.
Castañeda-Gutiérrez, E., M. J. de Veth, A. L. Lock, D. A. Dwyer, K. D. Murphy, and D.E. Bauman. 2007. Effect of supplementation with calcium salts of fish oil on n-3 fatty acids in milk fat. J. Dairy Sci. 90:4149-4156.
Chilliard, Y., A. Ferlay, R. M. Mansbridge, and M. Doreau. 2000. 309 Ruminant milk fat plasticity: nutritional control of saturated, polyunsaturated, trans and conjugated fatty acids. Ann. Zootech. 49:181-205.
Ervin, R. B., J. D. Wright, C.-Y. Wang, and J. Kennedy-Stephenson. 2004. Dietary intake of fats and fatty acids for the United States Population: 1999-2000. Adv. Data 348:1-6.
Fox, D. G., L. O. Tedeschi, T. P. Tylutki, J. B. Russell, M. E. Van Amburgh, L. E. Chase, A. N. Pell, and T. R. Overton. 2004. The Cornell Net Carbohydrate and Protein System model for evaluating herd nutrition and nutrient excretion. Anim. Feed Sci. Technol. 112:29-78.
Francois, C. A., S. L. Connor, L. C. Bolewicz and W. E. Connor. 2003. Supplementing lactating women with flaxseed oil does not increase docosahexaenoic acid in their milk. Am. J. Clin. Nutr. 77:226-233.
Gebauer, S. K., T. L. Psota, W. S. Harris, and P. M. Kris-Etherton. 2006. n-3 Fatty acid dietary recommendations and food sources to achieve essentiality and cardiovascular benefits. Am. J. Clin. Nutr. 83 (suppl.):15265-15355.
Glasser, F., A. Ferlay, and Y. Chilliard. 2008. Oilseed lipid supplements and fatty acid composition of cow milk: a meta-analysis. J. Dairy Sci. 91:4687-4703.
Hagemeister, H. D., D. Precht, M. Franzen, and C. A. Barth. 1991. α-Linolenic acid transfer into milk fat and its elongation by cows. Fat Sci. Technol. 93:387-391.
Hammond, B. G., J. K. Lemen, G. Ahmed, K. D. Miller, J. Kirkpatrick, and T. Fleeman. 2008. Safety assessment of SDA soybean oil: results of a 28-day gavage study and a 90-day/one generation reproduction feeding study in rats. Regul. Toxicol. Pharmacol. 52:311-323.
Harris, W. S., S. L. Lemke, S. N. Hansen, D. A. Goldstein, M. A. DiRienzo, H. Su, M. A. Nemet, M. L. Taylor, G. Ahmed, and C. George. 2008. Stearidonic acid 343 enhanced soybean oil increased the omega-3 index, an emerging cardiovascular risk marker. Lipids 43:805-811.
Harvatine, K. J., Y. R. Boisclair, and D. E. Bauman. 2009. Recent advances in the regulation of milk fat synthesis. Animal 3:40-54.
James, M. J., V. M. Ursin, and L. G. Cleland. 2003. Metabolism of stearidonic acid in human subjects: comparison with the metabolism of other n-3 fatty acids. Am. J. 351 Clin. Nutr. 77:1140-1145.
Jensen, R. G. 2002. Invited review: the composition of bovine milk lipids: January 1995 to December 2000. J. Dairy Sci. 85:295-350.
Lavie, C. J., R. V. Milani, M. R. Mehra, and H. O. Ventura. 2009. Omega-3 polyunsaturated fatty acids and cardiovascular diseases. J. Amer. Coll. Cardiol. 54:585-594.
Lock, A. L., and D. E. Bauman. 2004. Modifying milk fat composition of dairy cows to enhance fatty acids beneficial to human health. Lipids 39:1197-1206. National Research Council. 2001. Nutritional Requirements of Dairy Cattle. 7th 363 rev.ed. Natl. Acad. Sci., Washington D.C.
Palmquist, D. L. 2009. Omega-3 fatty acids in metabolism, health, and nutrition and for modified animal product foods. Professional An. Sci. 25:207-249.
Papas, A., S. H. Wu. 1997. Rumen-stable delivery systems. Adv Drug Deliv Ref 28:323-334.
Saito, Y., M. Yokoyama, H. Origasa, M. Matsuzake, Y. Matsuzawa, Y. Ishikawa, S. Oikawa, J. Sasaki, H. Hishida, H. Itakura, T. Kita, A. Kitabatake, N. Nakaya, T. Sakata, K. Shimada, and K. Shirato. 2008. Effects of EPA on coronary artery disease in hypercholesterolemic patients with multiple risk factors: sub-analysis of primary prevention cases from the Japan EPA Lipid Intervention Study (DELIS). Atherosclerosis 200:135-140.
Tyburczy, C., A. L. Lock, D. A. Dwyer, F. Destaillats, Z. Mouloungui, L. Candy, and D.E. Bauman. 2008. Uptake and utilization of trans octadecenoic acids in lactating dairy cows. J. Dairy Sci. 91:3850-3861.
Ursin, V. M. 2003. Modification of plant lipids for human health: development of functional land-based omega-3 fatty acids. J. Nutr. 133:4271-4274.
Wang, C., W. S. Harris, M. Chung, A. H. Lichtenstein, E. M. Balk, B. Kupelnick, H. S. Jordon, and J. Lau. 2006. n-3 Fatty acids from fish or fish-oil supplements, but not α-linolenic acid, benefit cardiovascular disease outcomes in primary- and secondary-prevention studies: a systematic review. Am. J. Clin. Nutr. 84:5-17.
Whelan, J. 2009. Dietary stearidonic acid is a long chain (n-3) polyunsaturated fatty acid with potential health benefits. J. Nutr. 139:5-10.
Whelan, J. and C Rust. 2006. Innovative dietary sources of n-3 fatty acids. Annu. Rev. Nutr. 26:75-103.
Yashodhara, B. M., S. Umakanth, J. M. Pappachan, S. K. Bhat, R. Kamath, and B. H. Choo. 2009. Omega-3 fatty acids: a comprehensive review of their role in health and disease. Postgrad. Med. J. 85:84-90.

1. A ruminant feed comprising: SDA; GLA; and, additional feed components, wherein the ruminant feed comprises at least about 0.05% by weight SDA and at least about 0.03% by weight GLA, wherein the ratio of SDA/GLA is at least about 1.3 and further comprises a fatty acid protective agent selected from the group consisting of undegradable proteins, whey protein gel complexes, protective coatings and encapsulation materials, and combinations thereof.

2. The ruminant feed as set forth in claim 1, wherein the ratio of SDA/GLA is from about 1.3 to about 6.0.

3. The ruminant feed as set forth in claim 1, wherein the SDA is derived from transgenic plant seeds and/or oil selected from the group of plants consisting of soybeans, canola, corn, and combinations thereof.

4. The ruminant feed of claim 3, wherein the SDA is derived from an SDA-enriched oil, and wherein the SDA-enriched oil is SDA-enriched soybean oil.

5. The ruminant feed of claim 4, wherein the SDA-enriched soybean oil comprises from about 10% (by weight) to about 30% (by weight) SDA.

6. The ruminant feed of claim 1, wherein the feed comprises at least about 1% by weight SDA.

7. The ruminant feed as set forth in claim 1 wherein the feed further comprises alpha-linolenic acid (ALA).

8. The ruminant feed as set forth in claim 7 wherein the ratio of SDA/ALA is at least about 0.1.

9. The ruminant feed as set forth in claim 1, wherein the feed further comprises fish oil.

10. The ruminant feed as set forth in claim 1 further comprising ALA in a concentration of at least about 0.5% by weight.

11. The ruminant feed as set forth in claim 1 wherein the feed is a dairy cattle feed.

12. The ruminant feed as set forth in claim 1 wherein the feed is a beef cattle feed.

13. The ruminant feed as set forth in claim 1, wherein the feed further comprises at least one ingredient selected from the group consisting of forages, grains, oilseed meals, byproducts, oils, vitamin and minerals, amino acids, antioxidants, tocochromanols, tocopherols, coccidostats, feed additives, buffers, mold inhibitors, yeasts, clays, tocochromanols, salt, and antibiotics.

14. (canceled)

15. A method of feeding a ruminant animal, the method comprising:
providing the ruminant feed as set forth in claim 1; and
feeding the ruminant feed to a plurality of ruminant animals.

16. The method as set forth in claim 15, wherein the ruminant feed comprises a concentration of GLA of at least about 0.5 g per 100 g total fatty acids, and a concentration of SDA of at least about 1.0 g per 100 g total fatty acids.

17. The method as set forth in claim 15, wherein the ruminant feed further comprises linoleic acid (LA), and wherein the ratio of concentrations of GLA/LA is at least about 0.05.

18. The method as set forth in claim 15, wherein the plurality of ruminant animals is a plurality of cattle.

19. The method as set forth in claim 15, wherein the feeding occurs on multiple occasions over a period of at least seven days.
